(19) United States
(12) Patent Application Publication
(10) Pub. No.: US 2002/0138714 A1
(43) Pub. Date: Sep. 26, 2002

(54) Scoreboard for scheduling of instructions in a microprocessor that provides out of order execution

(75) Inventors: Daniel Leibholz, Newton, MA (US); Poonacha Kongetira, Menlo Park, CA (US)

Correspondence Address: LAHIVE & COCKFIELD, 28 STATE STREET, BOSTON, MA, 02109, US

(73) Assignee: Sun Microsystems, Inc.

(21) Appl. No.: 09/816,291

(22) Filed: Mar. 22, 2001

(51) Int. Cl. G06F 9/30

(52) U.S. Cl. 712/217

(57) ABSTRACT

A system and method for scheduling instructions that are executed in the microprocessor are provided. The microprocessor executes multiple instructions per cycle that may have dependencies on execution results of other instructions. A scoreboard is utilized to schedule instructions. The scoreboard indicates dependencies between instructions. The scoreboard also controls the indication of dependencies based on the issuance of old instructions. The scoreboard includes a register for each instruction. The register has elements each of which corresponds to one of other instructions. An element of the register for an instruction is set where the element corresponds to one of other instructions which the instruction depends on.

### TECHNICAL FIELD

The present invention relates generally to microprocessor architecture and more particularly to a method and system for scheduling instructions that are executed in the microprocessor.

### BACKGROUND OF THE INVENTION

Reduced Instruction Set Processors (RISC) efficiently process a small set of instructions. RISC architecture optimizes each instruction so that it can be carried out rapidly. RISC chips execute simple instructions more quickly than general-purpose microprocessors. SPARC™ microprocessors are a family of RISC chips that comply with the Scalable Processor Architecture (SPARC) standards established by SPARC International.

Early RISC processors (including SPARC™ processors) were typically characterized by a single instruction-per-cycle execution. As the demands for higher operating speeds of processors have increased, the architecture of SPARC™ has changed to provide higher performance. The architecture includes support for advanced superscalar processor designs that enable the microprocessor to execute multiple instructions per cycle.

In a multiple instructions-per-cycle execution architecture, dependencies between instructions must be checked before executing the instructions. “Out-of-order” RISC processors operate generally by issuing sequences of instructions including “producer instructions” and “consumer instructions.” The producer instructions are instructions on which other instructions are dependent. The consumer instructions are instructions that depend on the producer instructions.

Certain conventional processors scan across a window of instructions to find sequences of instructions for execution. Consumer instructions may become ready to execute after producer instructions are executed. The processor selects instructions that are ready to execute and skips instructions that have dependencies on other instructions. It takes incrementally more time to scan across the window as the number of instructions within the window increases. Therefore, there is a tradeoff between window depth and the time taken to locate and execute instructions.

In a conventional SPARC™ architecture, dependencies between instructions are represented through the number of a physical register upon which a consumer instruction is dependent. When a producer instruction is executed, the register number is decoded and transmitted to the consumer instruction. The decoding step incurs significant delay, which limits the number of instructions that can be processed per cycle.

### SUMMARY OF THE INVENTION

The present invention provides a method and system for scheduling instructions in a microprocessor. More particularly, the present invention provides scheduling of instructions in multiple instructions-per-cycle execution architecture. The instructions executed in the present invention include a set of instructions that have dependencies on other instructions.

The object of the present invention is to provide a method and system for reducing time in scheduling instructions in a microprocessor. The method and system of the present invention scan instructions with minimum time to schedule the instructions.

Another object of the present invention is to provide a method and system for increasing depth of a window to schedule instructions in a microprocessor. The present invention increases the number of instructions that can be scheduled per cycle.

Another object of the present invention is to provide a method and system for minimizing time to transmit issuance of a producer instruction to consumer instructions. The issuance of the producer instruction is directly transmitted to the consumer instructions through a hardware scoreboard.

In accordance with one aspect of the present invention, a device for checking dependencies between instructions and issuing the instructions to an associated function unit is provided. The device includes a dependency unit that has a plurality of entries. Each entry corresponds to an instruction slated for execution. Elements of each entry indicate dependencies of the current instruction on other instructions. The elements located in the same position of the entries are connected so that issuance of a producer instruction is transmitted to consumer instructions.

In accordance with another aspect of the present invention, a device for scheduling instructions with dependencies between the instructions is provided. The device includes a checking unit for checking dependencies between the instructions to generate dependency indication vectors. The elements of a vector indicate dependencies on other instructions of an instruction to which the vector corresponds. The device also includes an issuing unit for issuing the instructions to an associated function unit by implementing in hardware the dependency indication vectors. The hardware adjusts the elements of the vectors to a state indicating no dependencies by connecting the elements of the vectors that are located at a same position in the vectors.

In accordance with a further aspect of the present invention, a microprocessor for checking dependencies between instructions and executing the instructions based on the dependencies is provided. The microprocessor includes a dependency checker for checking dependencies between instructions. The microprocessor utilizes a scoreboard to indicate the dependencies. The microprocessor selects instructions to be executed based on the scoreboard indication. The scoreboard controls the dependency indications as the instructions are executed.

In accordance with a still further aspect of the present invention, a method for checking dependencies between instructions and issuing the instructions to an associated function unit based is provided. The method examines dependencies between instructions. The dependencies are indicated in a scoreboard. A set of instructions that is ready to issue is selected based on the scoreboard indication. A predetermined number of the selected instructions are issued to the associated function unit.

The present invention provides an effective method and system for scheduling instructions in a microprocessor. The present invention reduces time to schedule instructions and increases the number of instructions executed at the same time in the microprocessor. However, the present invention is not limited to scheduling of instructions in the microprocessor. The present invention may be applied to any other scheduling mechanism for scheduling components that has dependencies on other components.

### BRIEF DESCRIPTION OF THE DRAWINGS

An illustrative embodiment of the present invention will be described below relative to the following drawings.

FIG. 1 is a block diagram that depicts structure of a microprocessor in which the illustrative embodiment of the present invention may be implemented.

FIG. 2 is an example of instructions executed by a microprocessor where the instructions are provided with identification numbers that are related with producer vectors of the instructions in the illustrative embodiment.

FIG. 3 is an example of producer vectors of instructions shown in FIG. 2 that are utilized to generate dependency indication vectors of the instructions in the illustrative embodiment.

FIG. 4 is an example of dependency indication vectors of instructions shown in FIG. 2 to indicate dependencies between the instructions in the illustrative embodiment.

FIG. 5 is exemplary structure of a scoreboard for utilizing producer vectors and dependency indication vectors to schedule instructions in the illustrative embodiment.

FIG. 6A is exemplary circuitry for discharging an element of registers in a scoreboard where the discharging circuit is triggered by granting signals for issuing producer instructions.

FIG. 6B shows a truth table for the NOR gate 601 of FIG. 6A.

FIG. 7 is an example of a scoreboard depicted in FIG. 5 to which dependency indication vectors shown in FIG. 4 are applied.

FIG. 8 is a flowchart of the steps performed in a scoreboard to schedule instructions in the illustrative embodiment of the present invention.

FIG. 9 is a flowchart that illustrates status changes of an instruction that has dependencies on other instructions.

### DETAILED DESCRIPTION OF THE INVENTION

The illustrative embodiment of the present invention concerns a microprocessor architecture that provides scheduling of instructions that are executed in the microprocessor. In particular, the microprocessor executes multiple instruction per cycle, and the instructions executed in the microprocessor include a set of instructions that have dependencies on execution results of other instructions in an immediately successive cycle.

The illustrative embodiment utilizes a hardware scoreboard to schedule instructions. The scoreboard indicates dependencies between instructions and controls the indication of dependencies based on the execution of old instructions. The scoreboard includes a dependency unit that has a plurality of entries to indicate dependencies. The dependency unit may be implemented to have has elements, each of which may have a binary value of 0 or 1 to indicate whether there is a dependency with an associated instruction. Each element corresponds to another instruction upon which the instruction may depend. A “1” value indicates there is a dependency and a “0” value indicates that there is no dependency.

The illustrative embodiment of the present invention provides an effective scheduling method and system for a microprocessor to execute multiple instructions per cycle. The illustrative embodiment enables a microprocessor to scan each successive instruction in a minimum amount of time. These features of the illustrative embodiment allow more instructions to be scanned for execution than in conventional systems.

In addition, the illustrative embodiment indicates that an instruction has been issued to other instructions that depends on the issued instruction through the hardware scoreboard. The dependencies between instructions are automatically resolved by the hardware scoreboard. The scoreboard implemented in hardware provides higher scanning speed to schedule instructions. Accordingly, the illustrative embodiment reduces time in scheduling instructions with dependencies between instructions.

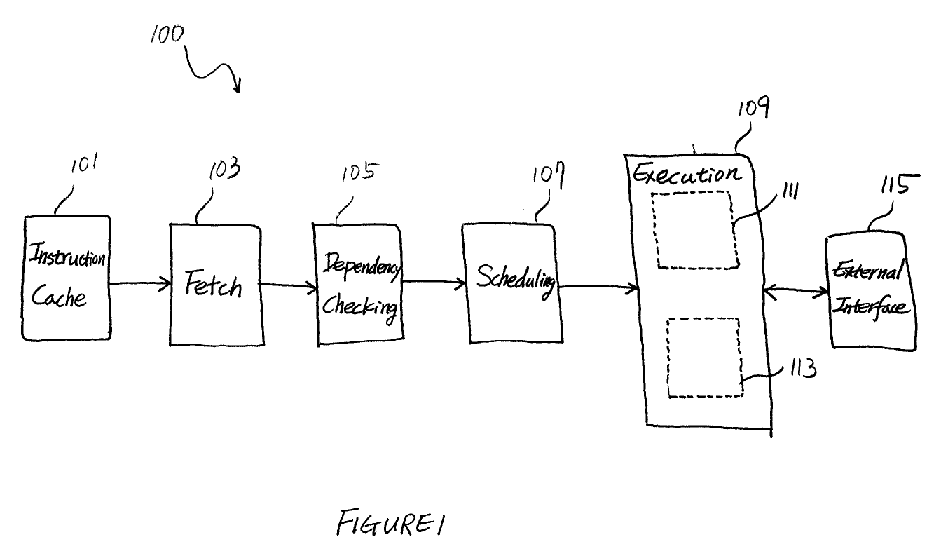

Referring to FIG. 1, a block diagram of a microprocessor is depicted to illustrate instruction flow in the microprocessor. The microprocessor 100 includes an instruction cache 101, a fetch unit 103, a dependency-checking unit 105, a scheduling unit 107, an execution unit 109 and an external interface unit 115. The instruction cache 101 temporarily stores a set of instructions so that the microprocessor 100 may conveniently access the next instructions in the program. The fetch unit 103 fetches bundles of instructions from the instruction cache 101 and then sends the resulting bundles of instructions to the dependency checking unit 105.

The dependency checking unit 105 determines dependencies between the instructions. The dependency checking unit 105 determines the dependencies between instructions in each fetched bundle (intra-dependency) and the dependencies between fetched bundles (inter-dependency). As each fetched bundle enters the dependency checking unit 105, an identification number is assigned to each instruction to identify the instruction. A “producer vector” is also assigned to each instruction based on the identification number. The producer vector may be implemented by a unit vector. The producer vector is described below in more detail.

The dependency checking unit 105 receives the bundle of instructions and updates the information it maintains to reflect the newly fetched instructions in the incoming bundle. The dependency checking unit 105 compares source registers of instructions in the incoming bundle with the destination register of old instructions that already exist in the dependency checking unit 105. The result of the comparisons is reflected in a dependency vector that is subsequently sent to the scheduling unit 107. The dependency vector may be implemented as a bit vector to indicate dependencies of a current instruction upon other instructions. The dependency vector may generated by combining the producer vectors of instructions upon which the current instruction depends. The elements of a dependency vector correspond with other instructions. The elements are set to “1” when the current instruction is dependent on the instructions to which the elements correspond. The dependency vector is described below in more detail.

As mentioned above, a bundle of instructions is fed from the dependency checking unit 105 with dependency information to the scheduling unit 107. The scheduling unit 107 utilizes a scoreboard for scheduling instructions. The scheduling unit 107 selects from any fed bundle instructions that are ready to issue in a first cycle. The instructions are ready to issue when all instructions upon which the current instructions depend have already been issued to the execution unit 109. The scheduling unit 107 selects in the next cycle at least some of the instructions for which any instructions on which the instructions depend have the execution results available. The selected instructions are issued to execution unit 109. The scheduling unit 107 broadcasts the issuance of the instructions to other instructions so that the other instructions can be ready to issue. While there are dependencies that have not been satisfied for a given set of instructions, the given set of instructions remains not ready to issue. The scheduling unit 107 selects instructions for issuance to the execution unit 109 based on criteria, such as a time sequence criteria in which instructions are selected for issue from the oldest ready instructions. The scheduling unit 107 is described below in more detail.

The execution unit 109 is capable of executing multiple instructions per cycle and includes multiple execution units 111 and 113. Information regarding what instructions have been executed is fed back to the scheduling unit 107 to inform the scheduling unit 107 of the availability of the execution results of the instructions. The scheduling unit 107 can issue ready instructions when the results of execution of the instructions upon which the ready instructions depend are available to the ready instructions.

The external interface unit 115 interfaces the microprocessor 100 with outside peripheral devices such as memory devices, input devices or output devices.

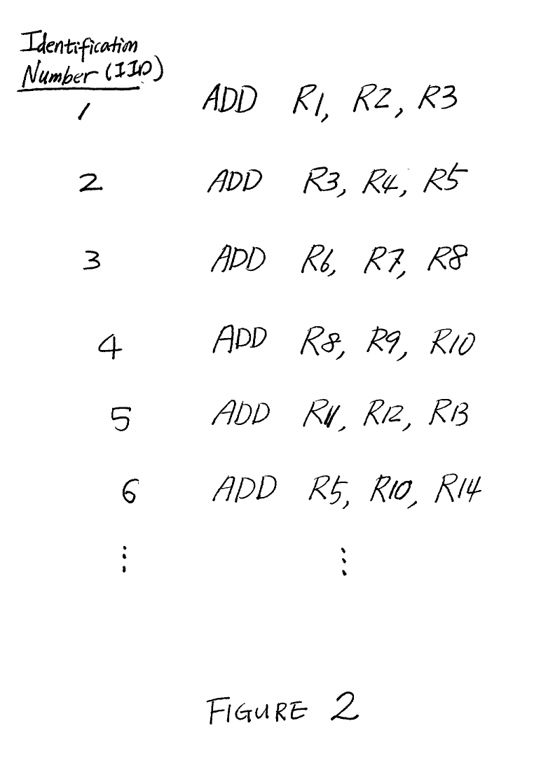

Referring to FIG. 2, an example of assembly language instructions executed in a microprocessor is provided. Those of skill in the art will appreciate that instructions expressed in a assembly language are converted to machine codes that can be accessed by the microprocessor. Each instruction includes an opcode that represents a specific function of the instruction. Instructions may also have an operand or operands including source registers or destination registers. For example, the first instruction in FIG. 2 identifies an addition operation that sums the contents of source registers R1 and R2. The result of the addition operation is stored in destination register R3. Similarly, the second instruction adds source registers R3 and R4 and stores the result in register R5. Those of skill in the art will appreciate that the source registers or the destination registers may be replaced by locations of a memory device outside the microprocessor. The microprocessor 100 may access a location of the memory device through the external interface unit 115.

The illustrative embodiment of the present invention employs an identification number for instructions (IID). Each instruction is provided with an IID to identify the instruction for internal purposes. As shown in FIG. 2, the first instruction is given an identification number 1. The second to the sixth instructions are provided with IID's of 2 through 6, respectively. The identification number of an instruction is used to generate a producer vector for the instruction. The relationship between an identification number and a producer vector is described below in more detail.

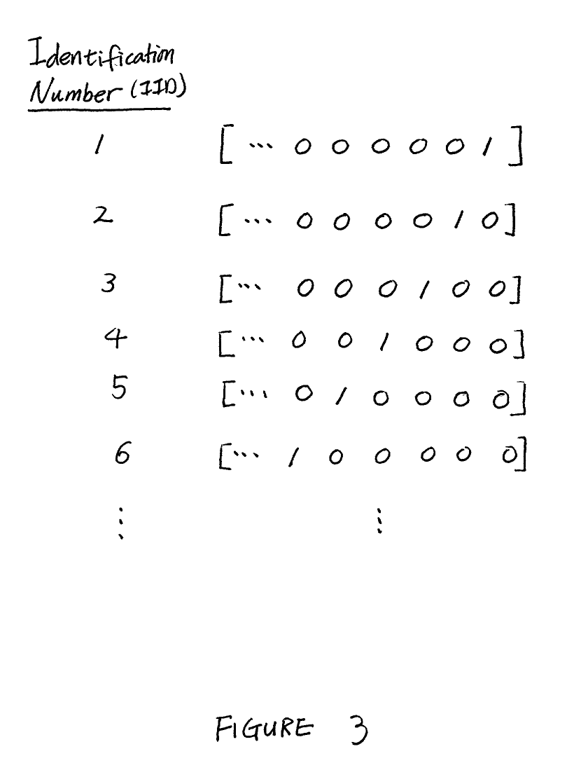

FIG. 3 is an example of producer vectors employed in the illustrative embodiment of the present invention. The illustrative embodiment provides each instruction with a producer vector. The producer vectors may be implemented using unit vectors in the illustrative embodiment. The identification number may be related with a producer vector that is assigned to each instruction. In particular, the identification number of an instruction may indicate the position of 1 in the producer vector of the instruction. For example the first instruction whose identification number is 1 is provided with a producer vector [. . . 000001]. The second instruction whose identification number is 2 is provided with a producer vector [. . . 000010] and the sixth instruction whose identification number is 6 is given a producer vector [. . . 100000]. It should be appreciated that an instruction can have a producer vector with multiple bits set.

The dependency checking unit 105 examines each instruction to determine dependencies between instructions. The dependency checking unit 105 compares source registers of instructions that currently enter the dependency checking unit with the destination register of old instructions that already exist in the dependency checking unit 105. The first, third and fifth instructions in FIG. 2 have no dependencies on other instructions. The destination register in the first instruction (IID of 1) is used as one of source registers in the second instruction (IID of 2). Therefore, the second instruction has dependency on the first instruction. The first and second instructions cannot be executed at the same time. The second instruction must be executed after the execution of the first instruction to utilize the result of the first instruction. Similarly, the destination register in the third instruction (IID of 3) is used as one of source registers in the fourth instructions (IID of 4). Therefore the forth instruction has dependency on the third instruction. In addition, the sixth instruction (IID of 6) utilizes the destination registers in the second and fourth instructions (IID's of 2 and 4) as source registers. The sixth instruction has dependencies on the second instruction that has dependency on the first instruction and fourth instruction that has dependency on the third instruction. Therefore, the sixth instruction must be executed after the execution of the first, second, third and fourth instructions.

After determining dependencies between instructions, the dependency checking unit 105 generates a dependency vector for each instruction. The illustrative embodiment of the present invention implements the dependency vector using a bit vector to indicate dependencies of a current instruction upon other instructions.

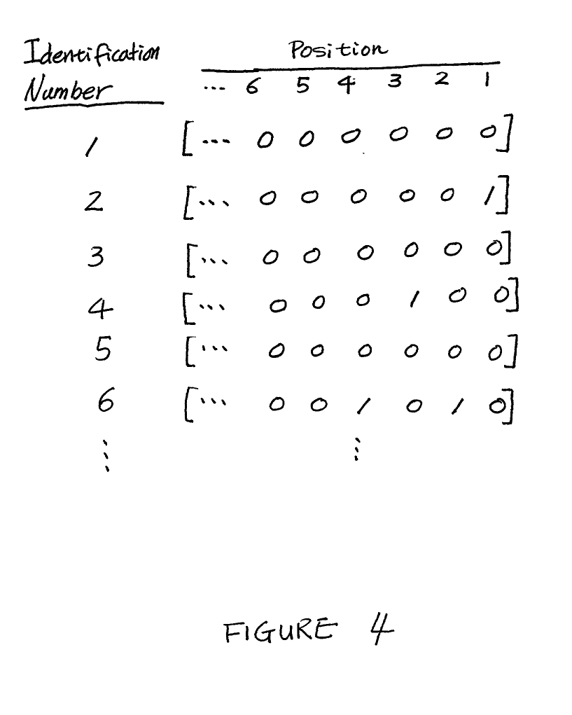

FIG. 4 is an example of a bit vector employed in the illustrative embodiment of the present invention to indicate dependencies between the instructions shown in FIG. 2. The bit vectors are combined into a vector table indexed by instruction identification number as shown in FIG. 4. The 1's in the bit vector correspond to other instructions upon which the instruction is dependent. The 1's in the bit vector indicate that the current instruction depends on instructions whose identification numbers correspond to the positions of the 1's in the bit vector.

The bit vector of an instruction may be generated by logically combining together producer vectors of instructions which the current instruction depends on. For example, all instructions are initially provided with a null vector [. . . 000000] to indicating that these instruction is ready to issue. The first, third and fifth instructions in FIG. 2, that are ready to issue, maintain the null vectors as producer vectors of the instructions. The second instruction that has a dependency on the first instruction is provided with a bit vector [. . . . 000001]. The bit vector of the second instruction is generated by combining a null vector with a producer vector [. . . 000001] of the first instruction. The position of 1 in the producer vector is 1 that corresponds to the identification number of the first instruction on which the second instruction depends. Similarly, the fourth instruction that has a dependency on the third instruction is provided with a bit vector [. . . 000100]. The bit vector of fourth instruction is generated by combining a null vector with the producer vector [. . . 000100] of the third instruction. The position of 1 in the producer vector is a third column that corresponds to the identification number 3 (IID of 3) of the third instruction on which the fourth instruction depends. In addition, the bit vector of sixth instruction that has dependencies on the second and fourth instructions is provided with a producer vector [. . . 001010]. The bit vector of the sixth instruction is generated by combining a null vector with the producer vectors [. . . 000010] and [. . 001000] of the second and fourth instructions. The positions of 1's in the producer vector are 2 and 4 that correspond to the identification numbers of the second and fourth instructions on which the sixth instruction depends.

The bit vectors that indicate dependencies between instructions are sent to the scheduling unit 107. The scheduling unit 107 of the illustrative embodiment includes the scoreboard for scheduling instruction. The illustrative embodiment implements the scoreboard using a plurality of registers.

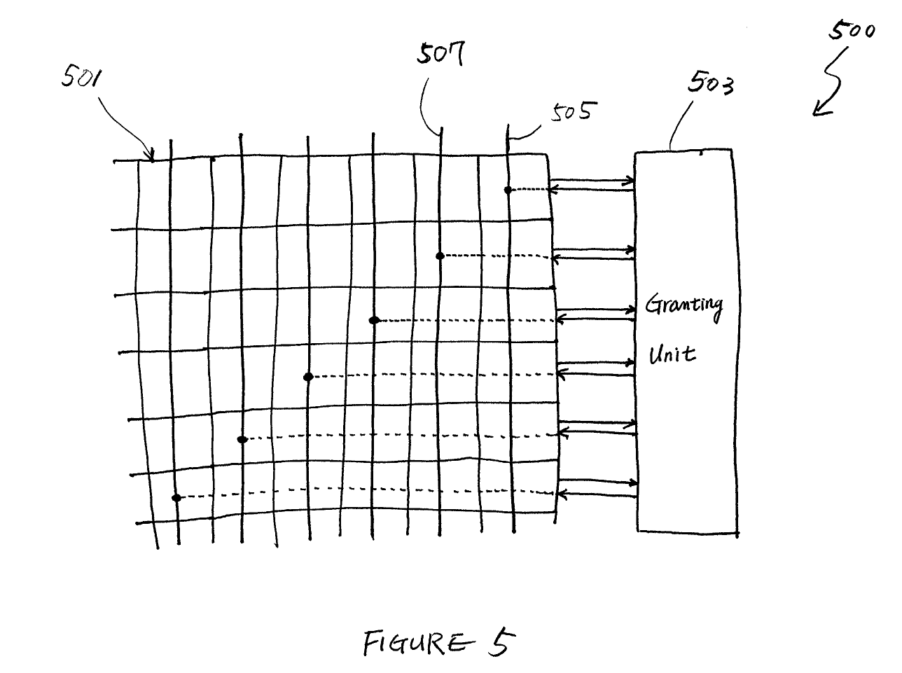

Referring to FIG. 5, a detailed structure of a scoreboard for scheduling instructions is depicted. The scoreboard indicates dependencies between instructions using a dependency unit that has a plurality of entries for indicating dependencies in the bit vectors. The dependency unit may be implemented by a register table 501 that includes a plurality of registers. Those of skill in the art will appreciate that the dependency unit may be implemented using a circuitry other than registers. The dependency unit may be implemented by using a circuitry that has a data holding places to indicate dependencies between instructions.

The scoreboard 500 includes register table 501 and granting unit 503. The register table 501 combines a plurality of registers. Each register may represent an instruction. The bit vector described above is input into the scoreboard so that the register table indicates dependencies between instructions. The register table represents dependencies between instructions that are initially created by the dependency checking unit 105 and reflects dependency changes of the instructions as instructions execute. Each element of a register that represents an instruction indicates a dependency of the instruction on one of other instructions. The element may be implemented using a memory cell. Binary values 1 and 0 for indicating a dependency of an instruction may be represented by charging or discharging the memory cell.

Each register makes a request for issuing an instruction which the register represents. The register makes a request for issuing the instruction when the instruction is ready to issue to execution unit 109. Where instructions upon which the current instruction depends are already issued to the execution unit 109, the scoreboard prevents the instruction from requesting again and again. The granting unit 503 generates signals for granting issuance of the instruction and sends the signals to the requesting register once the execution results of the instructions upon which the current instruction depends are available. For single-cycle integer operations, granting signals are generated one cycle after the issuance of instructions that the current instruction depends on. For multiple cycle operations, such as loads and floating point instructions, issuance takes place more than one cycle after the issuance of instructions that the current instruction depends on. The granting unit 503 chooses a predetermined number of instructions based on some criteria, such as time sequence criteria in which instructions are selected for issuance from oldest ready instructions. The number of instructions is determined by, for example, the number of instructions that can be executed at the same time in a microprocessor.

The scoreboard of the illustrative embodiment reflects the producer vectors shown in FIG. 3. The scoreboard 500 includes column connection lines 505 and 507 for vertically connecting elements at the same position of the registers. Elements of registers are connected with elements of other registers in the same column position. For example, the first column connection line 505 connects the elements at the first column in the registers. The second column connection line 507 connects the elements at a second column in the registers. The column connection lines 505 and 507 are also coupled with a granting unit 503 that generates granting signals for issue. The first column line 505 is coupled with the granting unit 503 at a first column element of the first register. Similarly, the second to sixth column lines are coupled with the granting unit 503 at the second to sixth column elements of the second to sixth registers, respectively. When the producer instructions are granted to issue, granting signals sent to the registers that represent producer instructions are transmitted to column elements of other registers so that consumer instructions that depend on the producer instructions are released from the dependencies on the producer instructions.

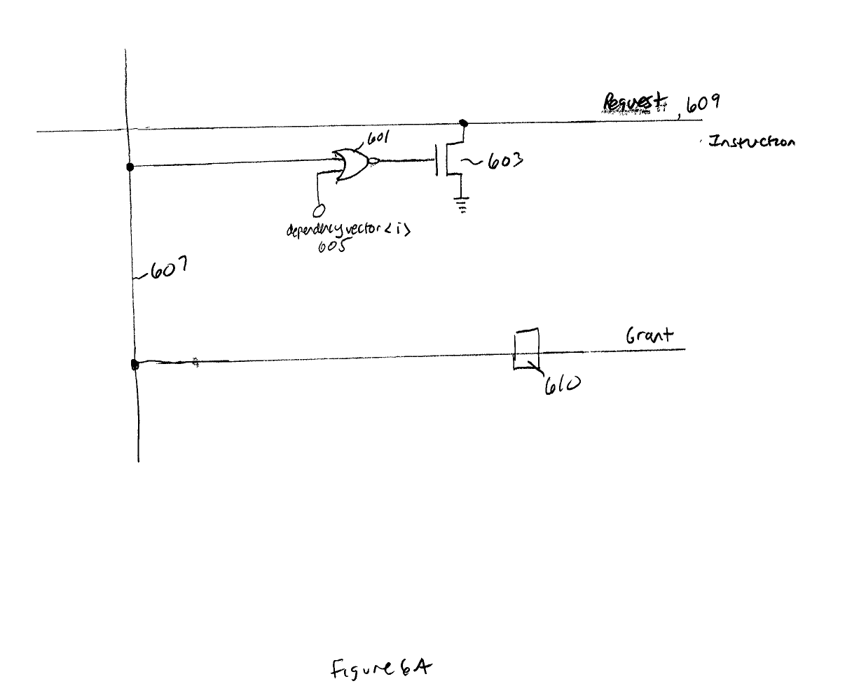

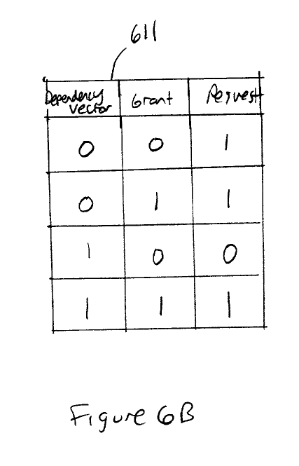

FIG. 6A is an example of circuitry for discharging elements of registers shown in FIG. 5. The discharging circuit includes a NOR gate 601 and a transistor 603. One of the input terminals of the NOR gate 601 is coupled to one of column connection lines 607 that connect elements located at a same position in the registers. As described above, the column connection lines are coupled with a granting unit 503. Logic 610 is included to hold the grant signal until new instructions enter the register and cause an “unhold.” The input terminal of the NOR gate 601 is also coupled to a bit in the dependency vector 605 for an instruction i, which indicates the instruction of the interest is dependent on instruction i. The output terminal of the NOR gate 601 is coupled to the transistor 603. The NOR gate 601 drives the transistor 603 in response to the signals transmitted through the column connection line 607 or a command signal for resetting the element. The transistor 603 triggered by the NOR gate 601 makes a path for discharging the elements. Those of skill in the art will appreciate that the discharging circuit is an illustrative embodiment for practicing the present invention and the discharging circuit may be implemented in other manner using different circuit devices.

FIG. 6B shows a truth table 611 for the output of the NOR gate 601. When the dependency vector bit 605 is low (i.e., zero), it is indication that the instruction of interest is not dependent of the instruction associated with the grant signal. In such a case, the instruction of interest may make a request (presuming there are no other outstanding dependencies) because there is no dependency outstanding. However, when the dependency vector bit 605 is set, the request may only be sent if the instruction i has already been issued and thus, the grant is set high (i.e., 1).

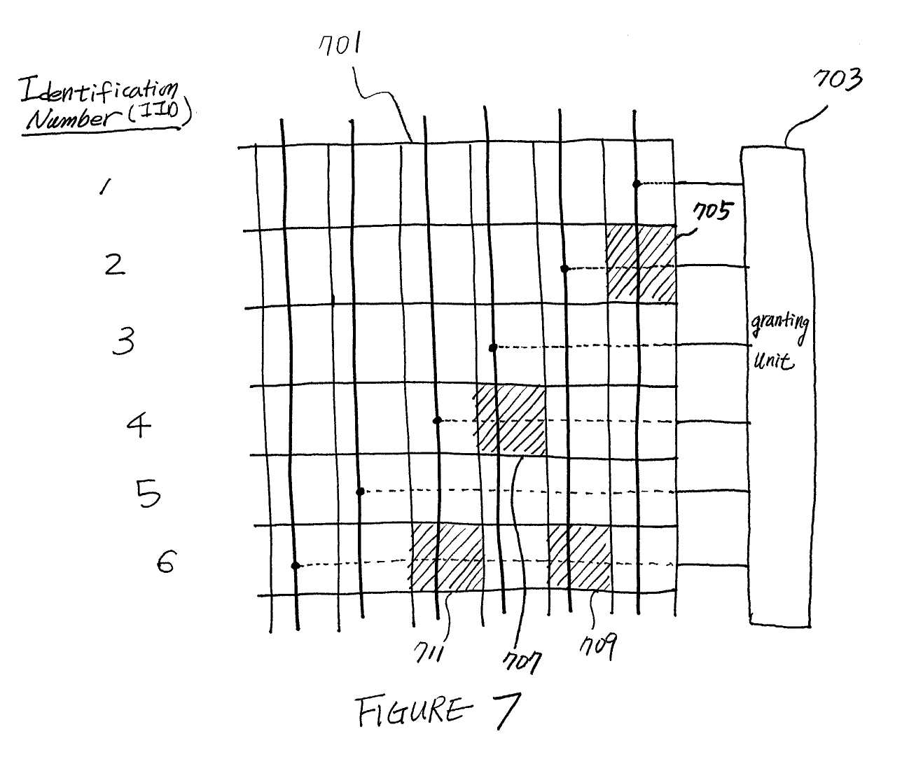

FIG. 7 is an example of scoreboard depicted in FIG. 5 to which an illustrative bit vectors shown in FIG. 4 are applied. The first column element 705 of the second register is charged to have a logical “1” value so that the element indicates that the second instruction (IID of 2) is dependent on the first instruction (IID of 1). In addition, the third element 707 of the fourth register is also set to 1 to represent that the four instruction (IID of 4) is dependent on the third instruction (IID of 3). In a similar manner, the second and forth elements 709 and 711 of the sixth register is charged to indicate that the sixth instruction (IID of 6) is dependent on the second and fourth instructions (IID's of 2 and 4).

Initially, the first, third and fifth registers make requests for issue. Assuming that two instructions are executed at the same time, the first and third instructions (IID's of 1 and 3) may be selected for issue based on time sequence criteria. Granting signals are transmitted to the first and third registers. These signals are sent to the first column element of the first register and the third element of the third register. These signals are also transmitted to the first column element 705 of the second register and the third element 707 of the fourth register. The first column element 705 of the second register and the third element 707 of the fourth register react accordingly. In the next place, the second, fourth and fifth instructions make requests for issue to the granting unit 703. The second and fourth instructions (IID's 2 and 4) may be selected for issue and granting signals are transmitted to the second and fourth registers. The signals are sent to the second column element of the second register and the fourth column element of the fourth register. These signals are also transmitted to the second and fourth column elements 709 and 711 of the sixth register. The second and fourth column elements of the sixth register are reset by discharging circuit shown in FIG. 6A. In the following place, the fifth and six instructions (IID's of 5 and 6) make requests for issue. The fifth and sixth instructions may be selected for issue and granting signals are transmitted to the fifth element of the fifth register and the sixth element of the sixth register. These signals are also transmitted to the fifth and sixth elements of other registers. The fifth and sixth elements of the registers are reset by discharging circuit.

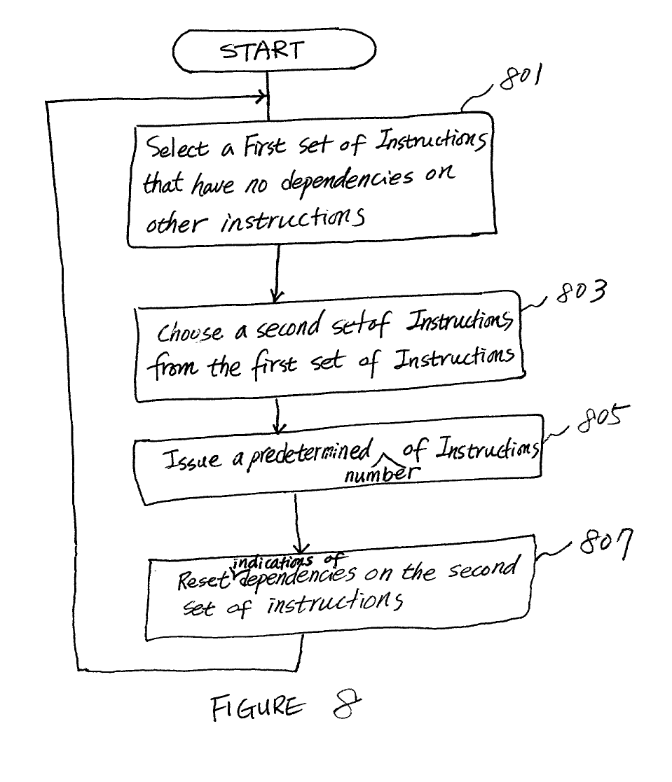

FIG. 8 is a flowchart of the steps performed by the scoreboard 500 in the illustrative embodiment of the present invention. The scoreboard selects a first set of instructions that are ready to issue based on the dependency indication of the register table 501 (step 801). An instruction becomes ready to issue when all elements of the register that represent the instruction are reset. The scoreboard 500 determines a second set of instructions from the first set of instruction (step 803). Execution results of instructions upon which the second set of instructions depends are available to the second set of instructions. The scoreboard 500 may choose a predetermined number of instructions from the second set of instructions based on some criteria, such as time sequence criteria in which instructions are selected for issue from oldest ready instructions. The number of instructions may also be determined by the number of execution units that execute instructions at the same time in a microprocessor. The scoreboard issues the instructions to execution unit 109 (step 805). The scoreboard 500 broadcasts issuance of the instructions to other instructions so that other instructions that depend on the issued instructions become ready to issue. The scoreboard 500 resets dependency indications on the second set of instructions (step 807). These steps 801-807 are iterated over remaining instruction.

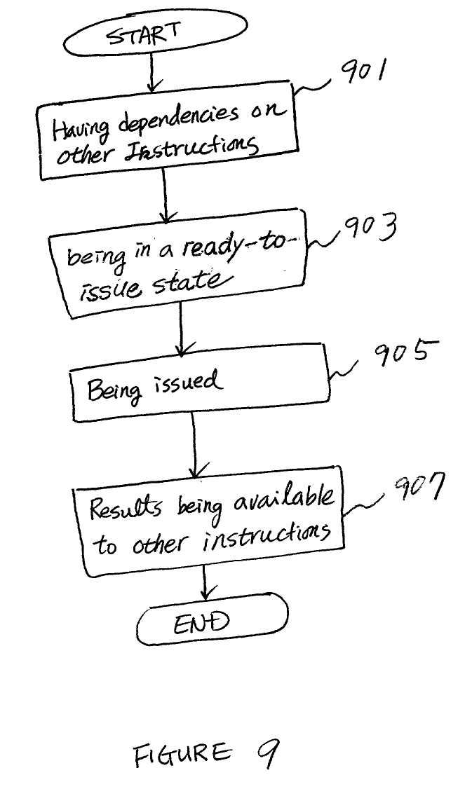

FIG. 9 is a flow chart that illustrates status changes of dependent instruction in the illustrative embodiment of the present invention. The current instructions fetched from an instruction cache 101 may include dependent instructions that utilize results of other instructions (step 901). Such dependent instructions are not ready to issue to execution unit 109 and wait for old instructions upon which the current instructions depend to generate needed results. Dependent instructions move to be ready to issue when old instructions upon which the dependent instructions depend are issued to execute (step 903). In a ready-to-issue state, the instructions make requests for issue to a execution unit 109. The instructions is selected and issued to execution unit 109 when old instructions upon which the current instructions depend are executed and the execution results are available to current instructions (step 905). Once current instructions are issued to execute, the execution results of the current instructions are available to other instructions that depend on the current instruction (step 907).

It is apparent that there has been provided, in accordance with the present invention, a method and system for scheduling instructions having dependencies on other instruction. While this invention has been described in conjunction with illustrative embodiments thereof, it is evident that many alternatives, modifications, and variations will be apparent to those skilled in the art. For example, the present invention can be applied to any type of scheduling system to schedule components that include components that depend on other components. Accordingly, it is intended to embrace all such alternatives, modifications and variations that fall within the spirit and broad scope of the appended claims.

What is claimed is:

1. A device for checking dependencies between instructions and issuing the instructions to an associated function unit based on the dependencies, said device comprising:
a dependency unit including a plurality of entries, each entry corresponding to an instruction slated for execution, elements of each entry indicating dependencies of the instruction on other instructions; and
connection lines for connecting elements of the entry that are located at a same position in the entries.

2. The device of claim 1 wherein said entries include registers that have elements indicating dependencies between instructions.

3. The device of claim 1 wherein said entries include circuitries that have a set of data holding places that indicates dependencies between the instructions.

4. The device of claim 1 wherein each said entry includes:
means for examining the elements of the entry to determine whether the instruction has dependencies on other instructions; and
means for making a request for issuing the instruction to be executed where the instruction is ready to issue.

5. The device of claim 1 further comprising a granting unit for generating to the entries in the dependency unit a signal for issuing instructions to the associated function unit.

6. The device of claim 5 wherein said granting unit is coupled with an entry located at n-th row in the dependency unit at n-th column element of the entry.

7. The device of claim 5 wherein said granting unit selects a predetermined number of instructions from instructions that make requests for issuing based on a selection criteria.

8. The device of claim 7 wherein said selection criteria includes a temporal criteria.

9. The device of claim 1 wherein said elements of each said entry are set where the instruction is dependent on another instruction to which the element of the entry corresponds.

10. The device of claim 1 further comprising means for manipulating elements of entries to a state indicating no dependencies, the resetting means being coupled with one of the connection lines.

11. The device of claim 5 further comprising means for manipulating elements of entries, the resetting means being triggered by the signal from the granting unit.

12. The device of claim 1 wherein each said element of each said entry is implemented using a memory cell.

13. A device for scheduling instructions with dependencies between the instructions, said device comprising:
a checking unit for checking dependencies between the instructions to generate dependency indication vectors having elements, said elements of a vector indicating dependencies of an instruction on other instructions;
an issuing unit for issuing the instructions to an associated function unit by implementing in hardware the dependency indication vectors, said hardware resetting the elements of the vectors to a state indicating no dependencies by connecting the elements of the vectors that are located at a same position in the vectors.

14. The device of claim 13 wherein said issuing unit implements the dependency indication vectors by using circuitries that have a set of data holding places that indicates dependencies between instructions.

15. The device of claim 14 wherein said circuitries includes registers that have elements indicating dependencies between instructions.

16. The device of claim 13 wherein said issuing unit implements the elements of the dependency indication vectors by using a memory cell that has a logical value of “0” or “1” to indicate dependency of an instruction on other instruction.

17. The device of claim 13 wherein said issuing unit transmits an issue signal of an instruction to instructions that depend on the issued instruction by connection lines, connection lines connecting the elements of the vectors that are located at a same position in the vectors.

18. The device of claim 17 wherein said issuing unit comprises manipulating means for manipulating the elements of the dependency indication vector to a state indicating no dependencies.

19. The device of claim 18 wherein said manipulating means is implemented in hardware.

20. The device of claim 18 wherein said the manipulating means being coupled with one of connection lines connecting the elements of the vectors that are located at a same position in the vectors.

21. In a microprocessor architecture, a method for checking dependencies between instructions and issuing the instructions to an associated function unit based on the dependencies, the method comprising steps of:
checking dependencies between the instructions;
providing a scoreboard that indicates the dependencies between the instructions;
selecting a first set of instructions that are ready to issue based on the scoreboard indication; and
issuing a second set of instructions to the associated function unit, the second set of instructions being chosen from the first set of instructions.

22. The method of claim 21 further comprising the steps of:
broadcasting issuance of the second set of instructions to other instructions that depend on the second set of instruction; and
adjusting dependencies of other instructions on the second set of instructions based on the broadcast of the issuance of the second set of instructions.

23. The method of claim 22 wherein the dependencies of other instructions on the second set of instructions are adjusted substantially at a same of the issuance of the second set of instructions

24. The method of claim 21 further comprising the steps of:
selecting a third set of instructions that are ready to issue, the third set of instructions including instructions that has dependencies on the second set of instructions issued to the associated function unit.

25. The method of claim 24 further comprising the step of issuing the fourth set of instructions to the associated function unit in the following cycle, the fourth set of instructions being chosen from the third set of instructions.

26. The method of claim 21 wherein the first set of instructions are selected based on a predetermined number of instructions that can be executed at the same time in a microprocessor.

27. The method of claim 21 wherein the first set of instructions is selected based on a plurality of criteria including a temporal criteria.

28. The method of claim 21 wherein said step of providing a scoreboard comprising:
providing a entry for an instructions wherein each element of the entry corresponds to one of other instructions; and
setting elements of the entry corresponding to other instructions which the instruction depends on.

29. The method of claim 25 wherein said step of selecting a first set of instruction comprises:
examining the elements of the entry to determine whether the instruction has dependencies on other instructions; and
where an instruction is ready to issue, selecting the instruction.

30. A microprocessor for checking dependencies between instructions and scheduling the instructions based on the dependencies, said microprocessor comprising:
a checker for checking dependencies between the instructions;
a dependency unit for indicating the dependencies between the instructions; and
a granting unit for generating signals for issuing instructions to an associated function unit based on the indication of the dependency unit.

31. The microprocessor of claim 30 wherein said dependency unit comprises:
entries for representing instructions wherein said entries have elements that correspond to other instructions; and
wherein an element of a entry provided for an instruction is set where the instruction is dependent on one of other instructions which the element corresponds to.

32. The microprocessor of claim 31 wherein said dependency unit further comprises:
means for examining the elements of entries to determine whether the instruction has dependencies on other instructions; and
means for making a request for issuing the instruction to an associated function unit where the instruction is ready to issue.

33. The microprocessor of claim 32 wherein said granting unit grants signals for issuing instructions to a predetermined number of instructions from the instructions that make requests for issuing.

34. The microprocessor of claim 33 wherein said granting unit grants signals for issuing instructions to a predetermined number of instructions that can be executed at the same time in a microprocessor.

35. The microprocessor of claim 33 wherein said granting unit grants signals for issuing instructions to a predetermined number of instructions based on a plurality of criteria including a time sequence criteria.

36. The microprocessor of claim 31 wherein said dependency unit includes means for resetting elements of entries in response to the signals for issuing instructions.

37. The microprocessor of claim 31 wherein said elements at a same position in the entries are coupled and the coupled elements are manipulated substantially at the same time of issuance of instruction.
